(19) United States
(12) Patent Application Publication
(10) Pub. No.: US 2004/0179678 A1
(43) Pub. Date: Sep. 16, 2004

(54) Cradle for supporting various portable phones

(76) Inventor: Hsiu-Chu Hsu Li, Hsin Chuang City (TW)

Correspondence Address: Hsiu-Chu Hsu Li, P.O.Box 4-67, Hsin Chuang, Taipei, 242, TW

(21) Appl. No.: 10/388,827

(22) Filed: Mar. 14, 2003

(51) Int. Cl. H04M 1/00

(52) U.S. Cl. 379/441; 379/446

(57) ABSTRACT

A cradle includes an arm attached to a casing and having a flap for engaging with the phone piece, a slidable arm having a beam slidably attached to the casing and having a flap to engage with the phone piece. The beam includes a rack, a gear includes a pinion engaged with the rack of the beam. A lever is rotatably attached to the casing and has one end biased to engage with the gear and to lock the beam to the casing. A button is slidably received in the casing and engageable with the lever, to move the end of the lever away from the gear and to release the beam from the casing when the button is moved into the casing, and to allow phones of different widths to be solidly locked between the flaps of the arms.

### BACKGROUND OF THE INVENTION

1. Field of the Invention

The present invention relates to a cradle, and more particularly to a cradle for supporting various portable or mobile phones having different widths.

2. Description of the Prior Art

Typical cradles comprise two arms slidably attached to a housing, and biased toward each other with spring members, in order to clamp and support portable or mobile phones between the arms, and so as to attach the portable or mobile phones to the housing.

However, the spring members may not be used to solidly secure the portable or mobile phones between the arms, and the portable or mobile phones may be easily disengaged from the arms inadvertently.

The other typical cradles also comprise two arms slidably attached to a housing, and biased toward each other with spring members, and the arms are coupled together with a track-and-gear coupling device, for allowing the arms to be moved relative to each other. The arms may also be biased toward each other by the spring members, in order to clamp the portable or mobile phones between the arms, and so as to attach the portable or mobile phones to the housing.

However, when one of the arms is moved away from the other arm, such as leftward, for one step by the track-and-gear coupling device, the other arm may also be moved away from the other arm, rightward, also for one step by the track-and-gear coupling device, such that the two arms will be separated from each other for two steps each time. Similarly, the two arms will be moved toward each other for two steps each time, and sometime may not be used to solidly secure or retain the portable or mobile phones between the arms. In addition, the spring members also may not be used to solidly secure the portable or mobile phones between the arms.

The present invention has arisen to mitigate and/or obviate the afore-described disadvantages of the conventional cradles for portable or mobile phones.

### SUMMARY OF THE INVENTION

The primary objective of the present invention is to provide a cradle for supporting various portable or mobile phones having different widths.

The other objective of the present invention is to provide a cradle for solidly supporting and locking various portable or mobile phones thereon.

In accordance with one aspect of the invention, there is provided a cradle for supporting phone piece, the cradle comprising a casing, a first arm attached to the casing, and including a flap for engaging with the phone piece, a second arm including a beam slidably attached to the casing, and including a flap for engaging with the phone piece, the beam including a rack provided thereon, a gearing device including a gear and a pinion secured together, the pinion being engaged with the rack of the beam of the second arm, a lever rotatably attached to the casing, and including an end portion for engaging with the gear, means for biasing the end portion of the lever to engage with the gear, and to lock the beam and the second arm to the casing, and a button slidably received in the casing, and engageable with the lever, to force the end portion of the lever to be disengaged from the gear and to release the beam and the second arm from the casing when the button is moved into the casing. The flap of the second arm is moveable to engage with the phone piece when the end portion of the lever is disengaged from the gear by the button, such that various portable or mobile phones having different widths may be solidly retained and locked between the flaps of the arms.

The button includes a frame, the casing includes a stop engaged into the frame, and a spring engaged between the button and the stop, to bias the button out of the casing, and thus to disengage or to move the button away from the lever, for allowing the end portion of the lever to be forced to engage with the gear again by the biasing means.

The casing includes a hub provided therein, the lever includes a bead provided thereon and rotatably engaged in the hub of the casing, to rotatably secure the lever to the casing, and thus for allowing the end portion of the lever to be moved toward and to engage with the gear, and to be moved away from the gear and to be disengaged from the gear.

The first arm includes a bar having at least one oblong hole formed therein, and at least one fastener engaged through the oblong hole of the bar, to adjustably secure the bar of the first arm to the casing, and thus to secure or retain various portable or mobile phones having different widths between the flaps of the arms.

The casing includes at least one notch formed therein, the bar of the first arm includes at least one rib extended therefrom and slidably engaged in the notch of the casing, to guide the bar of the first arm to slide relative to the casing, and to prevent the bar of the first arm from being slide laterally relative to the casing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a cradle in accordance with the present invention;

FIG. 2 is a front view of the cradle;

FIG. 3 is a rear view of the cradle;

FIG. 4 is a rear view similar to FIG. 3, in which a housing of the cradle has been removed from the casing, in order to show the inner structure of the cradle;

FIG. 5 is a plan view illustrating a gearing device of the cradle;

FIGS. 6, 7, 8 are rear views similar to FIG. 3, illustrating the adjustment or the operation of the cradle; and

FIGS. 9, 10, 11 are front views of the cradles as shown in FIGS. 6-8 respectively, illustrating the operation of the cradle to support various portable or mobile phones having different widths.

### DETAILED DESCRIPTION OF THE PREFERRED EMBODIMENT

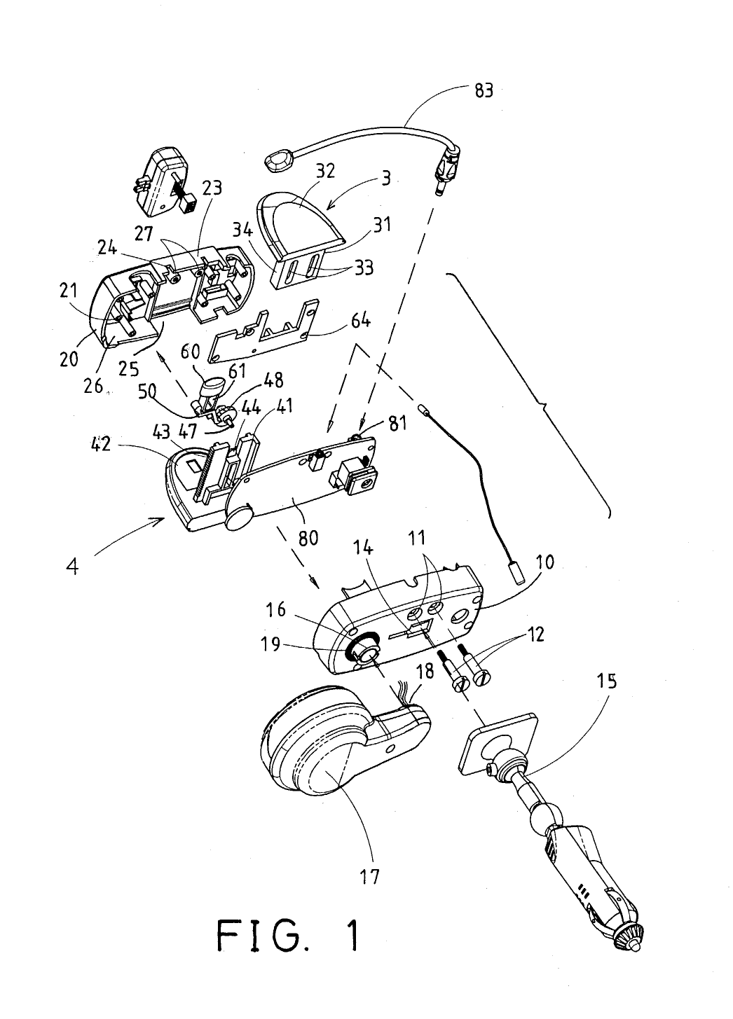

Referring to the drawings, and initially to FIGS. 1-5, a cradle in accordance with the present invention comprises a housing 10 including one or more orifices 11 formed therein for receiving fasteners 12 therein respectively. The fasteners 12 may be engaged into the housing 10. The housing 10 includes a lock notch 14 formed therein for coupling a plug or coupler or adapter 15, which may be coupled to the electric power source of the vehicle, for example.

The housing 10 further includes a hub 16, and a speaker 17 includes a shaft 18 extended therefrom and rotatably engaged into the hub 16 of the housing 10, for rotatably and adjustably secured to the housing 10. The speaker 17 may be positioned to the housing 10 at selected angular positions by serrated surfaces or teeth 19 (FIG. 1), or the like.

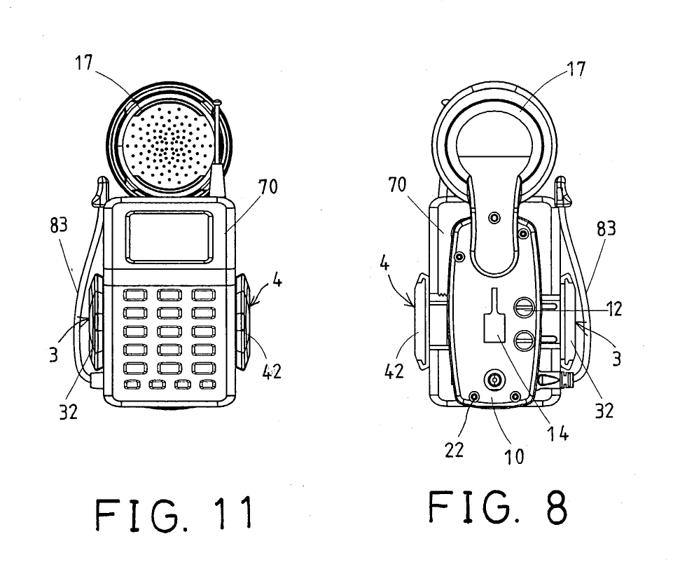

A casing 20 is engaged onto the front portion of the housing 10, and includes one or more pegs 21 provided thereon, a number of fasteners 22 (FIGS. 3 and 6-8) may be engaged through the housing 10 and engaged with the pegs 21, in order to secure the housing 10 and the casing 20 together. The casing 20 includes one side panel 23 having one or more notches 24 formed therein, and includes an opening 25 formed in the other side panel 26 thereof.

The casing 20 includes one or more studs 27 provided or extended therein. A first arm 3 includes a bar 31 slidably engaged between the housing 10 and the casing 20, or movable into the housing 10 or the casing 20, and includes one or more oblong holes 33 formed therein to slidably receive the fasteners 12 therein, and to slidably or adjustably secure the first arm 3 to the housing 10 or the casing 20.

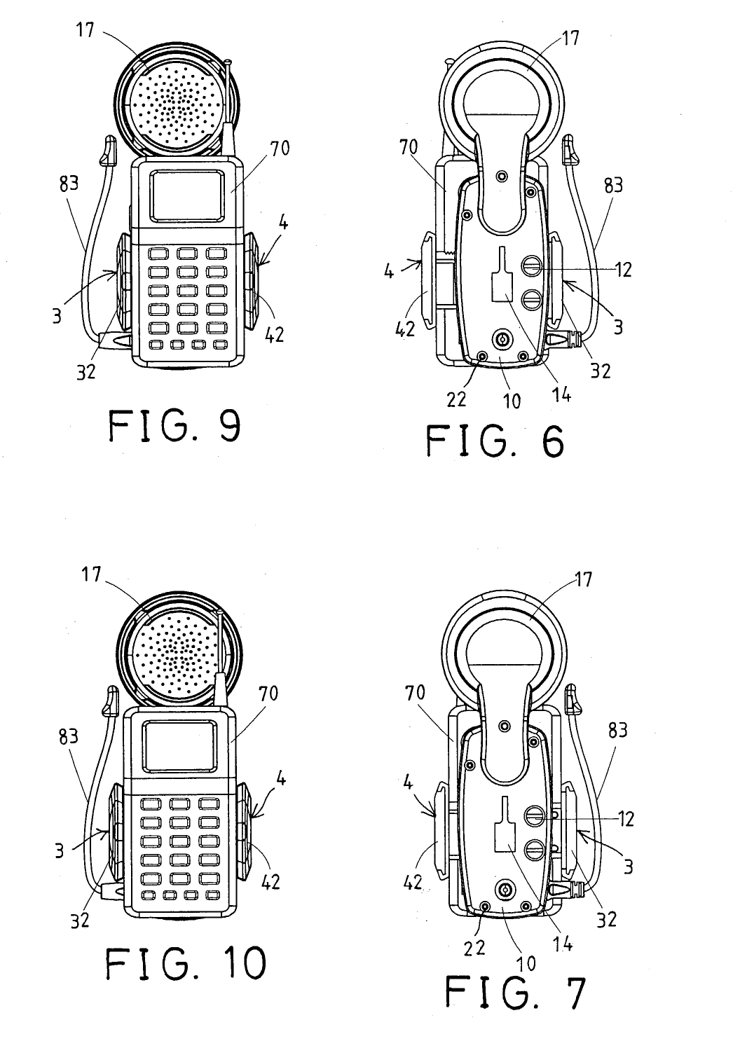

The first arm 3 further includes one or more ribs 34 extended from the bar 31 thereof, and slidably engaged in the corresponding notches 24 of the casing 20, in order to further guide the first arm 3 to slide relative to the housing 10 or the casing 20. The first arm 3 includes a flap 32 extended from the bar 31, for engaging with the portable or mobile phones or phone pieces 70 (FIGS. 6-11).

The fasteners 12 may be threaded to the studs 27 of the casing 20, in order to secure the first arm 3 to the housing 10 or the casing 20. The first arm 3 may also be adjusted relative to the housing 10 or the casing 20 by sliding the fasteners 12 along the oblong holes 33 of the first arm 3, before the fasteners 12 are solidly threaded or secured to the studs 27 of the casing 20, in order to adjust the flap 32 relative to the housing 10, and to engage with various portable or mobile phones of different widths.

A second arm 4 includes a beam 41 slidably engaged through the opening 25 of the casing 20, and includes a flap 42 extended from the beam 41, for engaging with the portable or mobile phones 70 (FIGS. 6-11). The beam 41 includes a rack 43 formed or provided on one side thereof, and a depression 44 formed therein to receive one end of a spring 45 (FIG. 4). The spring 45 may bias the second arm 4 away from the first arm 3.

A gearing device 46 is rotatably secured to the housing 10 or the casing 20 with a pivot axle 47, and includes a gear 48 and a pinion 49 formed or secured together and rotated in concert with each other (FIG. 5). The pinion 49 is engaged with the rack 43 of the beam 41 of the second arm 40, such that the gearing device 46 may be rotated by the beam 41 when the beam 41 is moved relative to the housing 10 or the casing 20.

A lever 50 includes a ball or a bead 51 formed or provided on one end thereof and rotatably secured to the housing 10 or the casing 20 with a hub 52, for allowing the lever 50 to be rotated relative to the housing 10 or the casing 20. The lever 50 includes another end 53 for engaging with the gear 48, and a spring 54 is engaged with the lever 50 to bias the end 53 of the lever 50 to engage with the gear 48, and thus to position or to lock the beam 41 of the second arm 4 relative to the housing 10 or the casing 20, and to prevent the second arm 4 from being moved relative to the housing 10 or the casing 20.

A button 60 is slidably received in the housing 10 or the casing 20, and includes a frame 61 slidably received in the casing 20. A stop 62 is extended from the housing 10 or the casing 20, and engaged into the frame 61. A spring 63 is received in the frame 61, and engaged between the stop 62 and the button 60, to bias the button 60 out of the housing 10 or the casing 20. The frame 61 of the button 60 is engaged with the lever 50.

As shown in FIG. 4, when the button 60 is depressed into the housing 10 or the casing 20 against the spring 63, the button 60 or the frame 61 may move or rotate the lever 50 against the spring 54, in order to disengage the end 53 of the lever 50 from the gear 48 of the gearing device 46. At this moment, or when the end 53 of the lever 50 is disengaged from the gear 48, the beam 41 and thus the second arm 4 may be moved or biased out or away from the housing 10 or the casing 20 by the spring 45.

When the button 60 is released, the spring 63 may bias the button 60 away from the lever 50, for allowing the end 53 of the lever 50 to be forced or biased to engage with the gear 48 again, by the spring 54, in order to position or to lock the beam 41 of the second arm 4 to the housing 10 or the casing 20 again. A cap 64 (FIG. 1) may be secured to the casing 20, to retain the lever 50 and the button 60 and the springs 54, 63 within the casing 20.

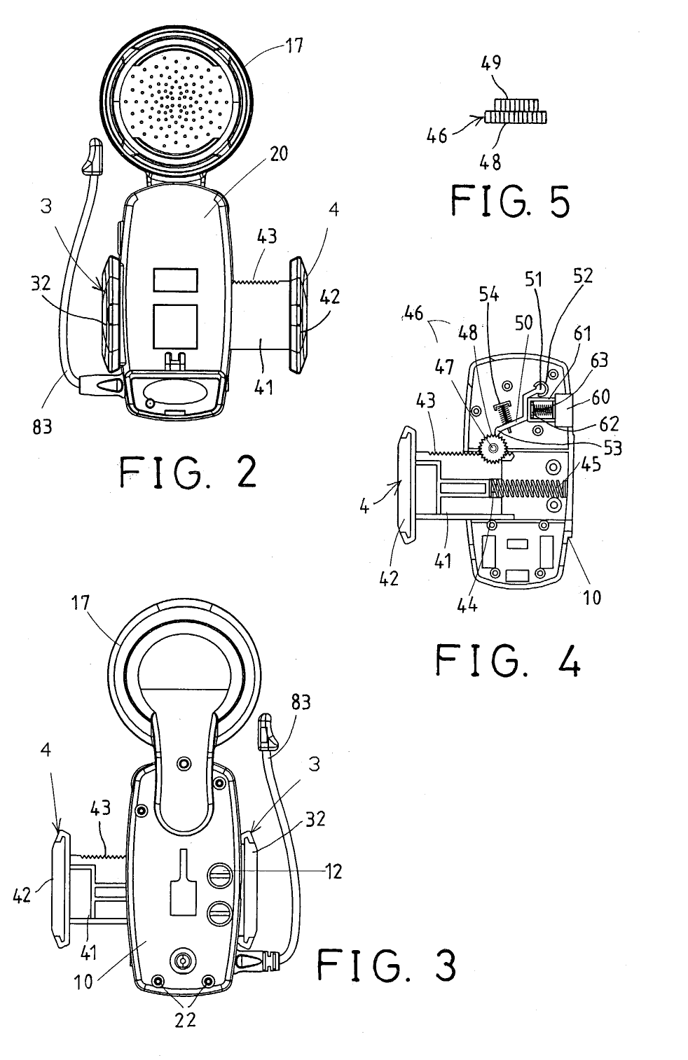

As shown in FIG. 1, a circuit board 80 may further be provided and secured to the housing 10 or the casing 20 with fasteners or the like, and may include a plug or coupler 81 provided thereon for plugging or coupling a microphone 83 thereto (FIGS. 2, 3 and 6-11).

In operation, the bar 31 of the first arm 3 may be adjusted relative to the housing 10 by the sliding movement of the fasteners 12 in the oblong holes 33 of the bar 31 relatively, for allowing the flap 32 of the first arm 3 to retain and to support various portable or mobile phones 70 of different widths (FIGS. 6-11).

The flap 42 of the second arm 4 may be moved or biased away from the first arm 3 or the housing 10 or the casing 20 by the spring 45 when the end 53 of the lever 50 is forced to be disengaged from the gear 48 of the gearing device 46 by depressing the button 60 into the housing 10 or the casing 20, and the portable or mobile phone 70 may then be easily engaged onto the casing 20 or disposed between the flaps 32, 42 of the arms 3, 4.

The flap 42 of the arm 4 may then be forced toward the first arm 3, to engage with the portable or mobile phone 70, and to clamp or retain the portable or mobile phone 70 between the flaps 32, 42 of the arms 3, 4 again. The end 53 of the lever 50 may then be biased to engage with the gear 48 again by the spring 54, when the button 60 is released and when the spring 63 biases the button 60 away from the lever 50, in order to lock the beam 41 of the second arm 4 to the housing 10 or the casing 20 again, and thus to solidly retain the portable or mobile phone 70 between the flaps 32, 42 of the arms 3, 4.

Accordingly, the cradle in accordance with the present invention may be used for supporting various portable or mobile phones having different widths, and for solidly locking the portable or mobile phones thereon.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cradle for supporting phone piece, said cradle comprising:
a casing,
a first arm attached to said casing, and including a flap for engaging with the phone piece,
a second arm including a beam slidably attached to said casing, and including a flap for engaging with the phone piece, said beam including a rack provided thereon,
a gearing device including a gear and a pinion secured together, said pinion being engaged with said rack of said beam of said second arm,
a lever rotatably attached to said casing, and including an end portion for engaging with said gear,
means for biasing said end portion of said lever to engage with said gear, and to lock said beam and said second arm to said casing, and
a button slidably received in said casing, and engageable with said lever, to force said end portion of said lever to be disengaged from said gear and to release said beam and said second arm from said casing when said button is moved into said casing,
said flap of said second arm being moveable to engage with the phone piece when said end portion of said lever is disengaged from said gear by said button.

2. The cradle as claimed in claim 1, wherein said button includes a frame, said casing includes a stop engaged into said frame, and a spring engaged between said button and said stop, to bias said button out of said casing.

3. The cradle as claimed in claim 1, wherein said casing includes a hub provided therein, said lever includes a bead provided thereon and rotatably engaged in said hub of said casing, to rotatably secure said lever to said casing.

4. The cradle as claimed in claim 1, wherein said first arm includes a bar having at least one oblong hole formed therein, and at least one fastener engaged through said at least one oblong hole of said bar, to adjustably secure said bar of said first arm to said casing.

5. The cradle as claimed in claim 4, wherein said casing includes at least one notch formed therein, said bar of said first arm includes at least one rib extended therefrom and slidably engaged in said at least one notch of said casing, to guide said bar of said first arm to slide relative to said casing.
